(19) United States
(12) Patent Application Publication
(10) Pub. No.: US 2002/0180810 A1
(43) Pub. Date: Dec. 5, 2002

(54) Compensation of workflow applications

(75) Inventors: Graham C. Charters, Southampton (GB); Amanda E. Chessell, Alton (GB); Vernon M. Green, Newbury (GB); Catherine S. Griffin, Romsey (GB); David J. Vines, Romsey (GB)

Correspondence Address: David A. Mims, Jr., IBM Corp, IP Law, 11400 Burnett Road, Zip 4054, Austin, TX, 78758, US

(73) Assignee: International Business Machines Corporation, Armonk, NY

(21) Appl. No.: 10/093,466

(22) Filed: Mar. 7, 2002

(30) Foreign Application Priority Data
May 30, 2001 (GB) 0113051.7

(51) Int. Cl. G09G 5/00

(52) U.S. Cl. 345/853

(57) ABSTRACT

Compensation of workflow applications represented by a graph is achieved by including graphical representations of paired primary and compensation tasks and of completion steps indicating success or failure of a process. Execution of a completion step indicating failure of the process causes one or more compensation tasks to run and execution of a completion step indicating success causes commitment of the results of previously executed primary tasks. By associating both a successful and an unsuccessful completion step with a process end point, a compensation group is defined. By associating only an unsuccessful completion step with an inner process within a compensation group, compensation tasks within the inner process whose primary tasks have executed are run if the unsuccessful completion step is reached. Otherwise compensation is deferred pending the outcome of the completion steps of the compensation group. By associating only a successful completion step with an inner process within a compensation group, the results of the primary tasks within the inner process are committed, if the successful completion step is reached, preventing their subsequent compensation notwithstanding failure of the compensation group.

### FIELD OF THE INVENTION

The present invention is in the field of definition and execution of workflow graphs and more particularly, of graphs which are defined in a visual programming tool and include support for compensation groups.

### BACKGROUND OF THE INVENTION

Whilst traditional programming languages, such as C, C++ or Java, are very powerful and provide enormous scope to the programmer they are also complex and require extremely specialised skills. In addition complex applications require large amounts of code and often require a large team of programmers who are too far removed from the initial concepts and designs such that solutions become inefficient or different from that originally intended. As a result in some areas of software development, such as application programming, alternative techniques are evolving.

One such technique involves creating self contained pieces of software, known as components, and then scripting components together to create new components. The new component created is referred to as the parent component and its constituent components are referred to as child components. The scripting code controls execution of the parent process by controlling, for example when each child is run, where its inputs are from, where its outputs go, and what to do in the event of its failure. The basic philosophy is that, for example, business logic is written as small independent components, and applications are defined by combining these components so that they communicate in a loosely coupled manner within a managed environment. This enables application development to be much more rapid since reuse for components is possible and components have clear, well defined functions.

In general, there are two key approaches to scripting together components in order to build parent components.

The first approach is to use some kind of scripting language or programming language to control the running of child components. The main advantage of this approach is that the programmer has unlimited scope to “code” when the child components are started and what actions to take with the results. The disadvantage is that this coding is still a specialized skill, each parent component must be coded by hand and the previously mentioned problems associated with existing programming with languages such as C, C++ and Java are not fully addressed.

The second approach is to provide a “builder-type” development tool that allows the application developer to draw the child components and link them together to form a graph of components. Links, for example, join the output(s) of one child component to the input(s) of another, thus specifying child component inputs, outputs and the order in which they are run. At run time, an engine, known as a navigation engine, reads the graph description and runs the specified child components as specified by the graph, thus effectively automatically generating the scripting code of the first approach. Examples of this are the IBM products MQSeries Workflow and MQSeries Integrator.

“Production Workflow Concepts and Techniques” by Frank Leymann and Dieter Roller, 2000, ISBN 0-13-021753-0, discusses fully this type of “builder-type” programming and is currently considered the state of the art in this field.

An example of such a graph in a “builder-type” development tool is shown in FIG. 2 in which a parent process (201) with one input port (202) and 2 outputs ports (203,204), comprises 3 child components (206,207,208). Arrows, such as 205, connect the output ports of one component to the input ports of others, and therefore describe the control flow. Note that processes can be nested and so a child component of a process can also be a process. This is shown for child component 208 which is also a process which comprises one input (209), one output (210), and 4 child components (210,211,212,214). For a graph such as this, the navigation engine, on receipt of a control flow/data flow to the input 202), must: start component 206 and pass it the input flow; wait for component 206 to produce an output; end component 206; depending on which output from component 206 is generated, start either component 207 or 208 and pass it the input flow; and so on until the graph completes.

For this method of development to be used in business tasks the development tool must also provide support for transactions and compensation groups (also referred to as extended transactions). Transactions are used to ensure that steps in a designated unit of work either all work or all fail. For example transferring money from one account to another involves two steps: removing money from account 1; and adding money to account 2. In a transaction, both of these steps would be carried out but not finalised (committed), then if both were successfully carried out the changes are committed, but if one fails the other is backed out (rolled back). A problem with this type of transaction is that between carrying out and committing (or rolling back) the work, the accounts would be locked to ensure that changes in accounts are not visible until both are completed. This type of locking is not normally an issue because in most cases transactions execute in a matter of milliseconds, however in long running transactions this can become an issue.

For example, consider a unit of work for booking a holiday which involves the steps: reserve flights; reserve accommodation; debit customers credit card; and credit holiday company account. In this unit of work several steps could be relatively slow and it could be very undesirable to leave, for example, a section of a flight database locked whilst checking accommodation and a section of an accommodation database locked whilst clearing a credit card, as this could lose custom. As a result, in this scenario a compensation model can be employed.

Despite its name, programming using compensation is optimistic. It allows pieces of work, that are a part of an operation, to be completed (and possibly made visible and permanent) before other pieces of the operation have completed. It assumes this will not be a problem since, in most cases, the rest of the work will also complete successfully. However, for the cases where this does not happen, a piece of work is run to either undo the completed work, or to compensate for the fact that it had been done “in error”.

In the booking a holiday example, if compensation is employed, compensation tasks of cancel flight and cancel accommodation may be written. If so, the unit of work can be split into three transactions: reserve flights; reserve accommodation; and debit customers credit card and credit holiday company account. Now, for example, if reserve flight succeeds and reserve accommodation succeeds but the customers credit card is rejected the cancel flight and cancel accommodation transactions are run to compensate for the previously completed transactions. This grouping of transactions in this way is referred to as a compensation group.

An example of representing compensation in a “builder-type” programming environment is illustrated in FIG. 3. The holiday booking process (301) contains 3 child components (302,305,309) each of which represent a different transaction. Child components 302 and 305 each contain a primary task and an associated compensating task, primary tasks being reserve flight (303) and reserve accommodation (306), associated compensating tasks being cancel flight (304) and cancel accommodation (307) respectively. The third component is an obtain payment process (308), which comprises two child components: debit credit card (309) and credit holiday company account (310). In this example the navigation engine recognises that a process which contains two tasks, as depicted for components 302 and 305, represents a compensation pair comprising a primary task and a compensating task. It also considers the holiday booking process (301) to be the compensation sphere which defines the group of transactions which comprise the compensation group. Compensating tasks are run if, when the compensation sphere completes, it reports an outcome that indicates failure. In this example the holiday booking process (301) completes on first failure or complete success. In the instance of failure the compensating tasks, of the primary tasks that were successfully completed, are run.

In this example, and other prior art in the builder-type environment, a compensation sphere is used to define a compensation group. This effectively means drawing a box around the components that comprise the compensation group and completing the compensation group when control leaves the box. However, this is considered too restrictive and greater flexibility is required for some applications. Compensation in the workflow environment and the concept of compensation spheres are discussed at pages 259-274 of the above-referenced book “Production Workflow Concepts and Techniques” by Leymann and Roller.

### SUMMARY OF THE INVENTION

Compensation spheres are considered too restrictive in defining compensation groups and the present invention provides greater flexibility in defining compensation groups as is required for some applications.

Accordingly, a first aspect the present invention provides a data processing method for running a workflow application in a data processing system, the method comprising: running a workflow application, the application comprising a plurality of components, each component performing a defined function, one or more completion steps, the plurality of components and the one or more completion steps being arranged to form a graph, wherein one or more components are designated as primary tasks and each primary task is paired with none, one, or more other components which are designated as compensating tasks; interpreting and executing the graph wherein each time a primary task is run any compensating tasks that are paired with it are not run but added to a compensation group; and responsive to executing a completion step, completing a subset of the compensation group wherein the subset of the compensation group is not involved in subsequent completion of the compensation group.

According to a second aspect the present invention provides a computer program product comprising instructions which, when executed on a data processing system, causes said system to carry out the first aspect of the present invention.

This allows a subset of a compensation group to be completed without affecting the result of the remainder of the compensation group. Depending on whether completion steps indicate success or failure, the subset of the compensation group could either be forgotten, such that the compensating tasks that the subset contains are forgotten, or compensated such that the compensating tasks that the subset contains are run, respectively. Either way the subset of the compensation group is not involved in subsequent completion of the compensation group.

Note that a compensation group can contain only one compensating task and still have a subset as it is possible for the more than one instance of the same compensating tasks to be contained in a compensation group.

If completion steps indicate failure, the subset of the compensation group is completed by running the compensation tasks contained within it.

Alternatively, if the completion steps indicate success, the subset of the compensation group is completed by forgetting compensating tasks within it.

Greater flexibility can thus be incorporated into the invention if completion steps can be used to indicate either success or failure so that a completion step can be used-to either forget or compensate a subset of a compensation group, respectively, depending on what is appropriate.

Preferably completion steps can also be used to indicate the end of a compensation group and this will be the case if at least one completion step that indicates success and at least one completion step that indicates failure each share the same end point, which may be the next component in the graph. In this case only one of the completion steps will be executed in the graph and compensating tasks involved in the compensation group are either forgotten or run depending on whether the completion step indicates success or failure, respectively.

Preferably all primary and compensating tasks are contained within compensation pair processes wherein a compensation pair process normally contains a single primary task and a single compensating task although either task (but not both) can be omitted. In this case, in the event that a primary task is run and fails, any compensating task that is associated with it is forgotten such that it is not involved in subsequent completion of the compensation group;

Compensation groups may contain process which are components which contain other components. Components in a process can also be processes and so it is possible to have various levels of nesting of processes in a compensation group and a subset of a compensation group. In this case each process that runs in a compensation group can keep a list of the processes that it runs as part of the compensation group. Now when a completion step is run to indicate the completion of a compensation group, or a subset of the compensation group, the process in which the completion step is contained calls all processes in its process list with a completion call. The completion call indicates whether compensating tasks should be run or forgotten, according to what the completion step indicated. Each process that receives this call then passes it on to each process in its own process list, with the exception of a compensation pair process which either runs or forgets the compensating task depending on what the completion call indicates. After each process returns from the completion call, its record is removed from the process lists in which it was contained. If this method is followed the scope of a compensation group and a subset of the compensation group are clearly defined and processes that are completed in the subset of the compensation group are not involved in subsequent completion of the compensation group.

Preferably, rather than adding every process, run as part of a compensation group, to the process list of the process that ran it, only processes that are known to support the completion call are added. This enables a process that cannot to take part in a compensation group to be run from within the compensation group.

Preferably a process, which does not contain a compensating task and is involved in a compensation group, can notify the process that runs it that this is the case. This way the process that runs it does not need to add it to its process list. This provides the advantage that the completion call does not have percolate down nested processes only to find that no compensating tasks are called.

According to a third aspect, the invention also provides a method of running a software application represented by a workflow graph of interconnected executable components created using a graphical user interface, the graph comprising: process representations having inputs, outputs and executable components, one or more of said components including a compensation pair which comprises a primary task and a compensation task compensating for said primary task; and successful and unsuccessful completion step representations selectively associated with a process to indicate success or failure thereof; said method comprising the steps of executing the primary tasks of a process in accordance with the workflow graph to produce a result; executing an associated successful or unsuccessful completion step, depending on the result of execution of the primary tasks of said process; in response to execution of an unsuccessful completion step, executing compensation tasks in the one or more compensation pairs within said process whose primary tasks have executed; and in response to execution of a successful completion step committing the results of previously executed primary tasks in one or more compensation pairs within said process.

Preferably, the graph associates both a successful and an unsuccessful completion step representation with an end point of a compensation group consisting of a plurality of processes, whereby said method must either compensate or commit the results of the primary tasks of compensation pairs within said compensation group which have not otherwise been compensated or committed when said end point is reached.

Preferably, the graph may additionally associate only an unsuccessful completion step representation with an output of an inner process within a compensation group whereby said method comprises the further steps, in response to execution of said unsuccessful completion step, of executing the compensation tasks of compensation pairs within said inner process and, otherwise deferring compensation of compensation pairs within said inner process pending the outcome of the completion steps of the compensation group when said end point is reached.

Preferably, the graph may additional associate only a successful completion step representation with an output of an inner process within a compensation group whereby said method comprises the further steps, in response to execution of said successful completion step, of committing the results of already executed primary tasks within said inner process to prevent their subsequent compensation notwithstanding failure of the compensation group.

### BRIEF DESCRIPTION OF THE DRAWINGS

The invention will now be described, by way of example only, with reference to a preferred embodiment thereof, as illustrated in the accompanying drawings, in which:

FIG. 1 is a block diagram of a data processing environment in which the preferred embodiment of the present invention can be advantageously applied;

FIG. 2 is a block diagram of a example of a workflow graph according to the prior art;

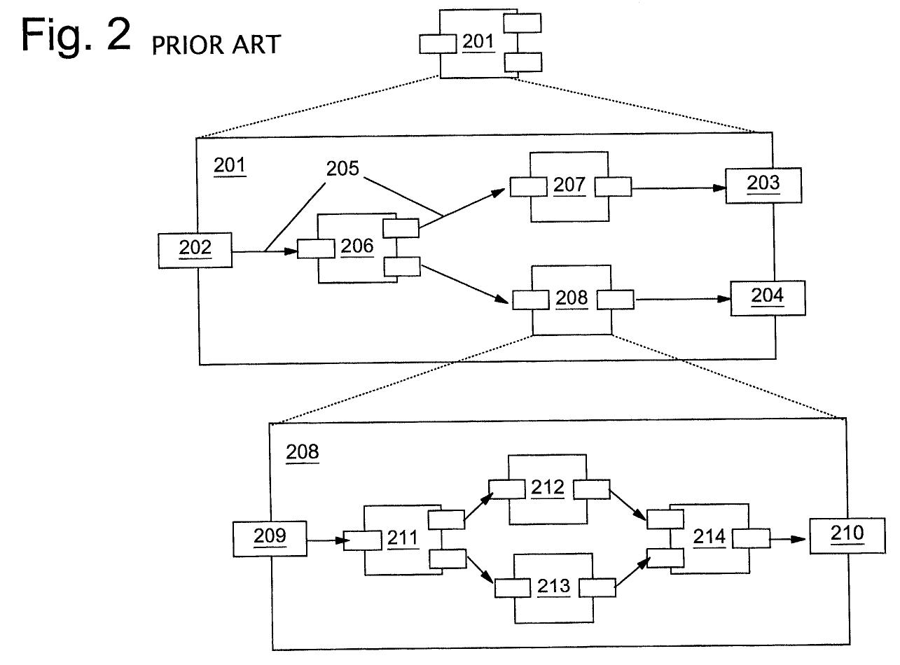

FIG. 3 is a block diagram of an example of a workflow graph which includes compensation of a compensation group according to the prior art;

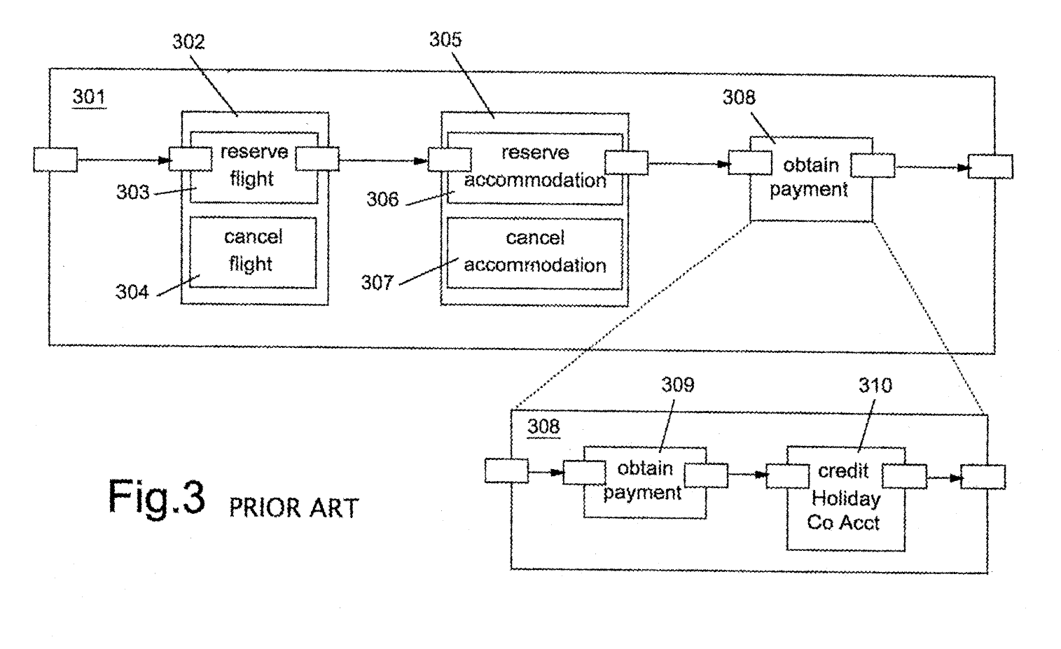

FIGS. 4a, 4b and 4c are visual representations of a compensation pair, an successful completion step and a unsuccessful completion step, respectively, according to the preferred embodiment of the present invention;

FIG. 5 is a block diagram of an example of a workflow graph which includes compensation of a compensation group according to the preferred embodiment of the present invention;

FIG. 6 is a block diagram of an example of a workflow graph which potentially includes more than one compensation group according to the preferred embodiment of the present invention;

FIG. 7 is a flow diagram illustrating execution of a child process according to the preferred method of the present invention; and

FIGS. 8a and 8b are flow diagrams illustrating the processing of a completion step and of a compensation pair process according to the present invention.

### DESCRIPTION OF THE PREFERRED EMBODIMENT OF THE INVENTION

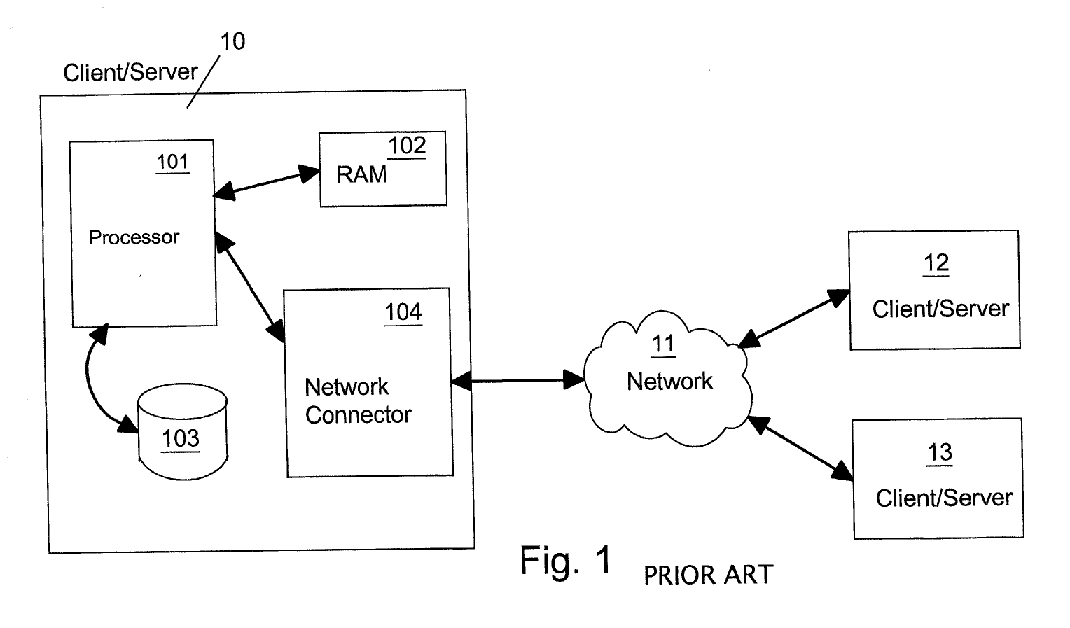

FIG. 1 is a block diagram of a data processing environment in which the preferred embodiment of the present invention can be advantageously applied; In FIG. 1, a client/server data processing apparatus 10 is connected to other client/server data processing apparatuses 12 and 13 via a network 11, which could be, for example, the Internet. The client/servers 10, 12 and 13 act in isolation or interact with each other, in the preferred embodiment, to carry out work, such as the definition and execution of a workflow graph, which may include compensation groups. Client/server 10 has a processor 101 for executing programs that control the operation of the client/server 10, a RAM volatile memory element 102, a non-volatile memory 103, and a network connector 104 for use in interfacing with the network 11 for communication with the other client/servers 12 and 13.

The preferred embodiment of the present invention is implemented in a “builder-type” development and execution environment for the programming of a business application. This environment is referred to as Business Process Beans (BPBeans). For development of the application, it is, of course, necessary that the environment of FIG. 1 should also include a display for displaying the workflow graph and user input means, such as a mouse and keyboard, for allowing the user to construct the graph interactively. BPBeans components are split into activities and processes:

An activity is a small JavaBean (“Java” and “JavaBean” are trademarks of Sun Microsystems, Inc.) which represents a very simple task that needs to be performed by the IT system. In general, this involves: processing some data; and maybe updating some stored data and producing a result. The data processed may be received as input or read from a database. Some activities are provided as part of BPBeans and others are written by application developers. Either way, they are combined together, in a graph, to form a process.

A process contains one or more components which could be activities and/or processes. Each process is therefore a parent and the activities and/or processes that it contains are its child components. A process is executed by a navigator which is responsible for controlling when and how many instances of the child components are created, run and removed. Child components can be connected together so that the output data from one becomes the input data for the next. This data is represented as a serializable Java object called a BPBean message.

Thus an application that uses Business Process Beans (BPBeans) contains a hierarchy of processes and activities that exchange messages. If these are defined well, each process at every level of this hierarchy should describe a useful business service since this increases understandability and reuse within the application. In addition processes and activities can be reused in many applications.

BPBeans also provides support for transactions and compensation groups. Compensation group support uses a compensation pair process which typically contains two tasks: a primary task is a component which is run when the process is activated and a compensation task is a component which is run if the primary task succeeds but another component in the compensation group fails, resulting in the need to compensate. Usually the compensating task is defined to undo the work of the primary task, although it may be defined to do something quite different, such as to retry the task. Note that it is possible to omit either the primary task or the compensation task from a compensation pair (but not both). Omitting the primary task occurs when a compensation task does not have an associated primary task. Placing just a primary task inside a compensation pair process means that any active compensation pairs nested inside the primary task are not involved in completion calls issued above the primary task.

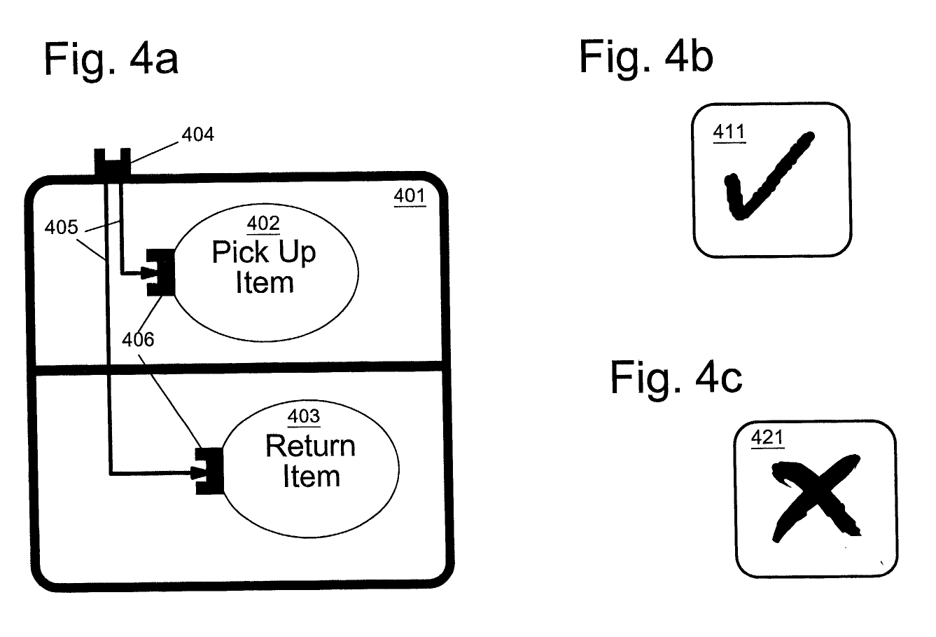

The BPBeans “builder-type” tool, used to generate the workflow graphs is called Application Builder for Components (ABC). FIG. 4a illustrates an example of the representation of a compensation pair process (401) in this tool. The compensation pair process shows a Pick Up Item component (402) at the top and a Return Item component (403) at the bottom. The component at the top is the primary task and the component at the bottom is the compensating task. In this figure the components that comprise the primary task and compensation tasks are activities. Also, for the compensation pair process (401) illustrated, any message received on input port 404 is duplicated and provided to both the primary task (402) and compensation task (403) via wires (405) and input ports (406). This means that if the compensation task (403) is run it will have available the input data that the primary task processed.

According to the present invention also available in the ABC tool are completion step activities. The are two types of these activities, a successful completion step and an unsuccessful completion step. The completion steps can be distributed around a workflow graph and used to complete a full or partial compensation group, a partial compensation group being a subset of a full compensation group. The scope of a full compensation group is defined by an outer set of completion step activities. An outer set of completion step activities comprise at least one successful completion step and at least one unsuccessful completion step which are defined at equivalent points in a workflow graph (i.e.: they have the same next processing step). For example, if the only way a process can exit is via either a successful completion step or a unsuccessful completion step, then the scope of the compensation group is all processes that were run since the process started or, if applicable, since the previous outer set of completion steps in the same process (i.e.: the scope includes child processes but not parent processes). As a result placing individual completion steps within an outer set of completion steps can cause partial completion (either by compensating or not) of a compensation group.

Note the term “full compensation group” refers to a compensation group of the prior art, such as one defined by a compensation sphere. In this specification it is referred to as “full” in order to distinguish it from a “partial compensation group”. Also note that in other embodiments a compensation sphere could be used to define a full compensation group and the completion steps of the present invention used to define a partial compensation group. In addition, in such an embodiment, successful completion steps are not required if only compensation of partial compensation groups is required as the compensation sphere would effectively provide a successful completion point.

FIG. 4b illustrates the representation of a successful completion step (411) in the ABC tool. A successful completion step indicates the successful completion of a full or partial compensation group and causes all of the compensation pair processes within the full or partial compensation group, that have successfully run their primary task, to end without running their compensating task. Note that any compensation pair processes, within the compensation group, that did not successfully run their primary task would have ended when the primary task finished.

FIG. 4c illustrates the representation of an unsuccessful completion step (411) in the ABC tool. An unsuccessful completion step indicates the failure of a full or partial compensation group and causes all of the compensation pair processes within the full or partial compensation group, that have successfully run their primary task, to run their compensating task and then end.

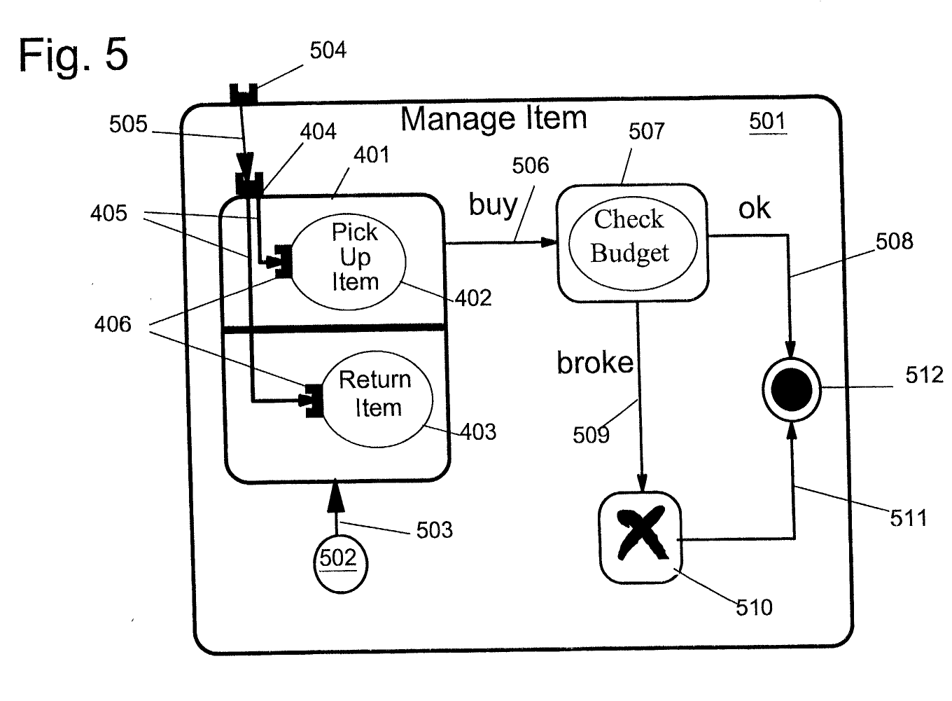

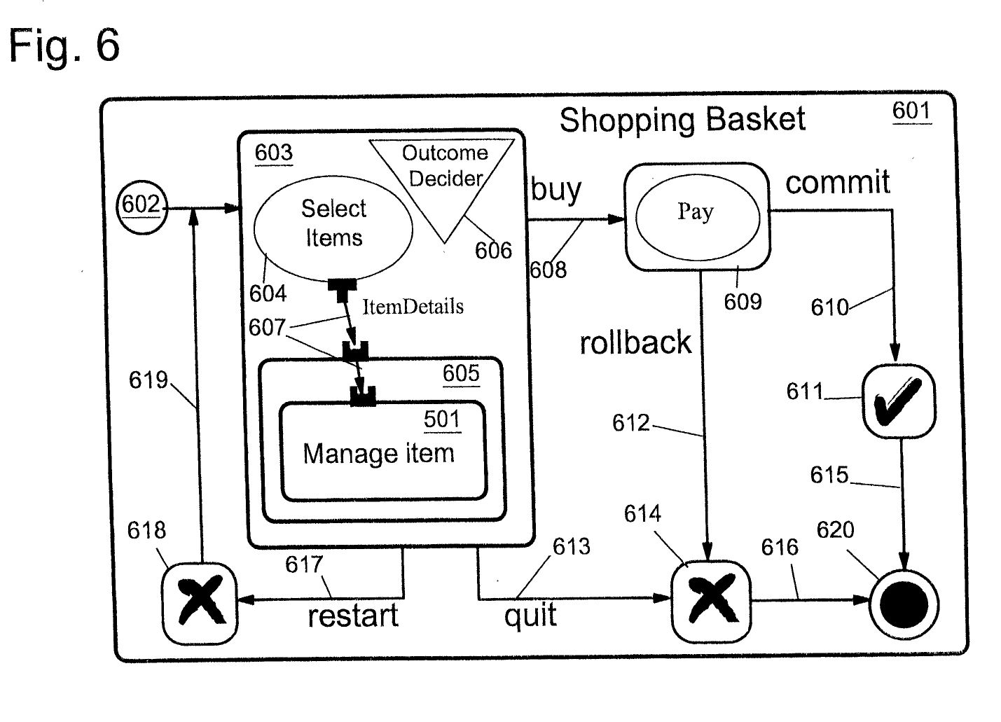

Note also that the completion step activities do not accept inputs and can only be included within a sequential process. A sequential process in BPBeans is a process in which the children are run one at a time according to a predefined sequence specified in its workflow graph. This, the use of completion steps, and the scope of a compensation group are now described by way of example in FIGS. 5 and 6.

FIG. 5 shows the compensation pair process of FIG. 4a incorporated into a Manage Item process (501) which is a simple sequential process that also includes an unsuccessful completion step (510). Note that in the figures, where a like part is included in more than one figure, it is given the same reference number in each figure. A sequential process has a start point, one or more end points, and runs one child component at a time in a predefined sequence. Process 501 has a start point (502), an end point (512), and arrows (503,506,508,509,511) that define the invocation sequence.

The first component to run is the compensation pair process (401) which starts the Pick Up Item activity (402) which is its primary task. This receives a message sent to the sequential process 501 via an input port (504) and delivered to the Pick Up Item activity via input ports (404,406) and wires (505,405). The message contains an item and its price. The Pick Up Item adds this item and its price to a shopping basket database (not shown). If this fails the Manage Item process (501) fails and ends, however, if it works the next child component in the sequence is started which is the Check Budget activity (507).

The Check Budget activity (507) calculates the total cost of the shopping basket (which may include more than one item if this process has been previously started) and compares it with a predefined shopping budget. If the budget has not been exceeded the Check Budget activity (507) reports an outcome of “ok” and process proceeds to the end point (512) at which point the process ends. However, if the budget has been exceeded the Check Budget activity (507) reports an outcome of “broke” and processing continues to the unsuccessful completion step (510) which causes all outstanding compensating tasks in this process and its children to be run. As a result the Return Item activity (403), which is the compensating task of the only child compensation pair process (401), is run. This uses the message that contains the item and price to remove the item from the shopping basket thus undoing the previous work of Pick Up Item. Once the Return Item Activity has ended processing continues to the end point (512) and the process ends.

Note that the Manage Item Process (501) does not include a successful completion step and so does not contain an outer set of completion steps and therefore does not define a full compensation group. As a result if the path through the unsuccessful completion step (510) is followed the compensation group is partially completed (in this case compensated). If the Manage Item process (501) completes without passing through the unsuccessful completion step (510), it is not partially completed and must wait for its parent to indicate the whether or not the compensation task (403) should be run.

FIG. 6. shows the Manage Item process (501) incorporated into a Shopping Basket process (601), which is a sequential process. The Shopping Basket process (601) contains an outer set of completion steps defined by successful completion step (611), and unsuccessful completion step (614). These are at an equivalent points in the process as they are both immediately followed by an end point (620). This process (601) also includes an unsuccessful completion step (618) which is not part of an outer completion step because there is no equivalent successful completion step (i.e.: immediately before starting process 603).

Process 603 is the first child component after the start point (602) and is run first. Process 603 is a concurrent process which means that all child components of the process are started at the same time. As a result both the Select Items activity (604) and process 605 are started. This concurrent process (603) also includes an outcome decider (606) which combines the outcomes of its children into a consolidated outcome, which in this example could be ‘buy’ or “quit”.

The Select Items activity (604) allows a shopper to specify a budget and select items for purchase. The budget is stored in a shopping basket database (not shown) and each time an item is selected a message is sent, along wire 607, containing details of the item selected and its price. When the shopper completes shopping they elect to “buy”, “quit”, or “restart”. Note that how the Select Items activity can provide this function to the end user is well known in the art and is not part of the present invention.

Process 605 is a message cluster process which means that it starts a new instance of its single child component to process each message that it receives. In the event that the child component instance fails, a replacement instance is created to process the message. This process completes when directed by its parent. Process 605 therefore starts a new instance of the Manage Item process (501) each time it receives a message. The Manage Item adds the item to the shopping basket unless the budget is exceeded as described for FIG. 5. If the budget is exceeded the shopper can continue shopping and may for example, increase the budget or select other cheaper items.

Note that because process 603 is a concurrent process and process 605 is a message cluster process the Select Items activity (604) runs at the same time as instances of the Manage Item process (501) and so more than one Manage Item process instance can be running at any one time.

Eventually the shopper decides to finish and selects to either “buy”, “quit”, or “restart” which the Select Items Activity (604) generates as an outcome. On receipt of this outcome the outcome decider directs message cluster process 605 to complete, which it does once all messages have been processed. Process 603 then completes using the outcome of the Select Items Activity (604).

If the outcome of process 603 is “restart”, processing continues to unsuccessful completion step (618). This causes all of the compensation pair processes, run since the start of the Shopping basket process (601), that have successfully run their primary task and not their compensating task, to run their compensating task and end. In this example this will cause the Return Item Activity (403—FIG. 4) of all Manage Item process (501) instances that have not previously run their compensation task, to be run, thus removing all remaining items from the shopping basket. This represent partial completion of the compensation group and processing then continues back into process 603.

If the outcome of process 603 is “quit”, processing continues to an unsuccessful completion step (614). The processing of this completion point is much the same as previously described completion point (618), thus emptying the shopping basket. However this completion step (614) is part of an outer set and so marks the end of the full compensation group.

If the outcome of process 603 is “buy”, processing continues to the Pay Activity (609). This activity credits the shoppers credit card and debits the shops bank account under the scope of a transaction. If for any reason the transaction fails, and is rolled back, processing once again continues to unsuccessful completion step (614) which causes the shopping basket to be emptied as previously described. However if the transaction is successful, and commits, processing continues to a successful completion step (611). This step cause all compensation tasks of the Manage Item process (501) instances that have not previously run their compensation task, to be forgotten, thus ending the full compensation group. As a result any compensation triggered by a parent process of the Shopping basket process (601) would have no effect on it. Once the completion step has finished processing continues to the end point (620) and the Shopping Basket process ends.

Thus, examples of the added flexibility of using completion steps compared to compensation spheres has been shown. This is because it not possible to partially complete a compensation group using spheres. For example, it is not possible to define a compensation sphere in FIG. 6 that would, in the event of failures, allow both the Manage Item process (501) to remove a single item from the basket and the Shopping Basket Process (601) to remove all remaining items from the basket. Referring to FIG. 5, this is because an inner compensation sphere around the Manage Item process would be required to cause the removal of a single item, but such a sphere would have the equivalent effect of adding a successful completion step after the Check Budget Process (507) has completed with an outcome of “ok”.

Further, with a compensation sphere, it would not be possible to restart process (603) after emptying the shopping basket without completing the compensation group and thus exiting the sphere.

It should be noted that FIGS. 5 and 6 are fairly simple examples of how the placement of completion steps are used to partially and fully complete a compensation group. However, the invention is very flexible and many more scenarios are possible.

Internally BPBeans supports the completion steps of the present invention by defining an extended parent/child contract. The basic contract allows a parent processes to start and stop its child components (the child instructs its parent when it can be stopped) and the extended contract further allows the parent process to complete its child processes. To make this possible the extended parent/child contract defines a “complete” method which a participating child process implements, and a participating parent process calls. The “complete” method is used to tell a process whether to compensate or whether to clean up because compensation will never be required.

Implementation of the extended parent/child contract is now discussed in term of four classes of process:

Class 1—Compensation Pair Process: A Compensation pair process participates in the extended contract as a child and therefore implements the “complete” method. When a compensation pair process is started it starts its primary task. When it is asked to stop, it stops the primary task. When it is asked to “complete”, it checks the boolean flag passed on the “complete” method. If the flag is true (i.e. a successful completion), it does nothing. However if the flag is false it starts the compensating task and waits for it to indicate that it has finished. Once this indication has been received the Compensation Pair Process stops the compensating task and returns.

Class 2—The Sequential Process: A sequential process participates in the extended contract as a child and a parent. As described for FIGS. 5 and 6 the completion steps of the present invention are included in sequential processes. As a sequential process steps through its child components, it starts a child component, waits for it to indicate that it wants to stop, stops it and then, if it is a process, places it on an “UncompletedProcess” queue. The UncompletedProcess queue is used to keep a record of processes that have not yet been called with “complete”. Now, when the sequential process reaches a completion step, it examines the UncompletedProcess queue and calls the “complete” method on each process in the queue, passing a boolean parameter indicating whether it was a successful (true) or unsuccessful (false) completion step. After all the processes in the UncompletedProcess queue have returned, the queue is cleared. If a sequence process does not end with a completion step, any processes still on the UncompletedProcess queue remain on the queue. Subsequently the sequential process is called to complete by its parent, at which time it examines the UncompletedProcess queue and calls the “complete” method on each process in the queue passing on the boolean parameter, indicating success or failure, that it received. Once again, after all the processes in the UncompletedProcess queue have returned, the queue is cleared.

Class 3—Other processes participating in the extended contract: In order to allow compensation pair processes to be nested within them, other process types (such as the concurrent process (603) and the message cluster process (605) of FIG. 6) must participate in the extended contract as both parent and child. These processes keep a record of the processes they start in an UncompletedProcess set, and then, when called with the “complete” method by their parent, call the “complete” method on each process in their UncompletedProcess set, passing on the boolean parameter. The UncompletedProcess set is then deleted once all processes have returned.

Class 4—Processes not participating in the extended contract: Processes which do not participate in the extended contract and therefore do not implement the completion method must be placed immediately under a compensation pair process. This ensures that the completion method is not required.

One improvement to this system is possible, if Class 2 and Class 3 processes check to see if their child components provide a completion method and only add those that do to their UncompletedProcess queue/set. This enables a Class 4 process to be nested inside any process (although any compensation group nested within it must also be completed within it).

A further improvement is also possible. This is to provide a mechanism for a Class 2 or Class 3 process to indicate to their parent whether or not they would do any work when called with “complete”. If no work would occur processing the method, the process need not be added to the UncompletedProcess queue/set. This would provide a performance improvement as it removes the need to percolate a “complete” method down a nest of processes which, for example, do not include a compensation pair process.

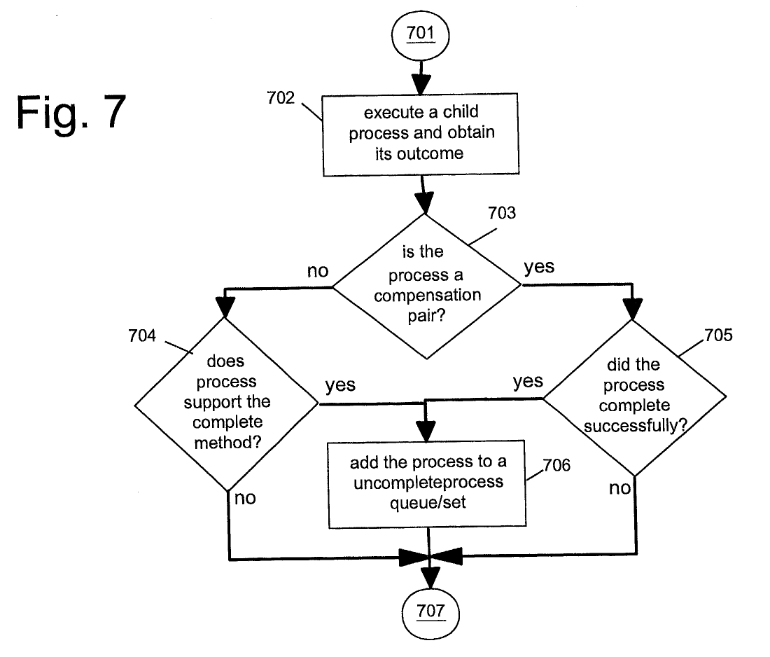

FIG. 7 shows processing of a Class 2 or Class 3 process for each child process it executes during normal processing of its graph, according the preferred embodiment of the present invention. At step 702 the process starts a child process and some time later obtains its outcome. Note that when each child process starts and finishes will depend on the internals of the process. When the child process completes, a check is made to see if it is a compensation pair process at step 703. If it is not a compensation pair process a check is made to see if it supports the “complete” method (i.e.: it is not Class 4 process), if it does, at step 707 details of the process are added to an UncompleteProcess queue/set for later reference, and if does not it is forgotten. However, if the child process was a compensation pair process, a check is made at step 705 to see if the primary task completed successfully. If it was successful details of the process are added to the UncompleteProcess queue/set for later reference, and if was not it is forgotten. As a result the UncompleteProcess queue/set contains details of all child processes that support the complete method.

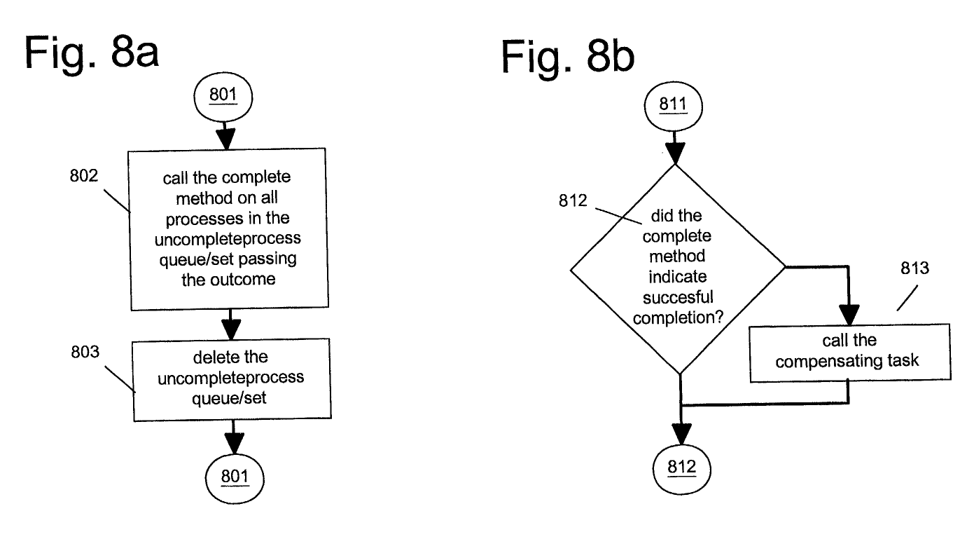

FIG. 8a shows processing of a Class 2 (sequential) process on encountering a completion step and a Class 2 or Class 3 process on receiving a complete method call from its parent. At step 802 it calls the complete method on all processes recorded in its UncompleteProcess queue/set. A boolean parameter is passed with the method which indicates success or failure, depending on whether the call resulted from a successful completion step or an unsuccessful completion step. Note that the completion step could be in this process (Class 2 process only) or one of its parents. After all processes have returned from the complete method the UncompleteProcess queue/set is deleted at step 803. Alternatively individual processes can be removed from the queue when they return. This processing ensures that a completion step triggers a complete method call on all processes nested inside the process that contains it.

FIG. 8b shows the processing of a compensation pair process on receipt of the complete method. At step 812 a check is made to see if the boolean parameter on the complete method indicates success. If it does the method simply returns, however, if it indicates failure the compensating task is started.

Thus the invention provides a very flexible system for marking the completion of compensation groups in a workflow graph. This allows the placement of several completion points for a given full compensation group, where completion points can indicate successful or unsuccessful completion. Further different paths through a graph can result in the early completion of a subset of a compensation group. For example, in processing the Shopping basket process (601—FIG. 6), each time the unsuccessful completion step (510—FIG. 5) of the Manage Item process (501—FIG. 5) is invoked, a subset of the compensation group is completed. However, if the unsuccessful completion step (510—FIG. 5) of the Manage Item process (501—FIG. 5) is never invoked, the Shopping Basket Process (601—FIG. 6) is completed in its entirety.

In other words process components have three methods—start( ), stop( ), complete( ). The time between start( ) and stop( ) is where the component does its work. The complete( ) call indicates whether to compensate or whether to clean up because compensation will never be required. Process components typically choose to pass on the completion request to any processes nested inside. When a component stops it chooses whether it wishes to be involved in the next completion call or not. This is done by registering the interest with the parent process component. The parent process component may choose to honour this by registering an interest in completion with its parent if it does not contain any completion steps itself.

The completion steps result in a completion call to all of the components that have registered an interest in it. They can be invoked partway through a compensation group's execution and then the group is able to continue. The unsuccessful completion step drives compensation whereas the successful completion allows the modeller to specify that compensation is never required on previously executed steps.

In addition, the method of denoting a completion step in the BPBeans ABC tool in the preferred embodiment of the present invention is just one such method of doing so. For example another method could be for a process to be configured such that a given outcome could result in a successful or unsuccessful completion step. In addition a compensation sphere could be used to define the full compensation group.

1. A data processing method for running a workflow application in a data processing system, the method comprising:
running a workflow application, the application comprising a plurality of components, each component performing a defined function, and one or more completion steps, the plurality of components and the one or more completion steps being arranged to form a graph, wherein one or more components are designated as primary tasks and each primary task is paired with none, one, or more other components which are designated as compensating tasks;
interpreting and executing the graph wherein each time a primary task is run any compensating tasks that are paired with it are not run but added to a compensation group; and
responsive to executing a completion step, completing a subset of the compensation group wherein the subset of the compensation group is not involved in subsequent completion of the compensation group.

2. A method as claimed in claim 1 wherein the one or more completion steps indicate failure for a subset of the compensation group and the step of completing a subset of the compensation group runs the compensating tasks contained in the subset of compensation group.

3. A method as claimed in claim 1 wherein the one or more completion steps indicate success for a subset of the compensation group and the step of completing a subset of the compensation group forgets the compensating tasks in the subset of the compensation group.

4. A method as claimed in claim 2 wherein each of the one or more completion steps indicates either success or failure for a subset of the compensation group, wherein the step of completing a subset of the compensation group is further responsive to the completion step indicating failure and the method further comprises the step:
responsive to executing a completion step that indicates success for a subset of the compensation group, forgetting the compensating tasks in the subset of the compensation group wherein the subset of the compensation group is not involved in subsequent completion of the compensation group.

5. The method of claim 4 wherein the method further comprises the steps of:
responsive to a completion step indicating success which shares the same next component in the graph with one or more completion steps indicating failure, completing the compensation group by forgetting all compensating tasks involved in the compensation group; and
responsive to a completion step indicating failure which shares the same next component in the graph with one or more completion steps which indicate success, completing the compensation group by running all compensating tasks involved in the compensation group.

6. A method as claimed in claim 1 wherein:
a component which comprises one or more other components is a process, the compensation group comprising one or more processes, all primary and compensating tasks being defined in one or more compensation pair processes each of which comprises at most one primary task and at most one compensating task; and
the method further comprising the step of:
responsive to a primary task failing which has an associated compensation task, forgetting the compensating task such that is not part of the compensation group.

7. A method as claimed in claim 6 wherein at least one of the one or more processes contained in the compensation group comprise one or more other process and the method further comprises the steps of:
maintaining, in each process that runs inside the compensation group, a process list containing a record of other processes run within that process as part of the compensation group;
responsive to a completion step, calling each process in the process list maintained for the process in which the completion step was contained, wherein the call is a completion call which indicates whether compensating tasks should be run or forgotten;
responsive to a process which is not a compensation pair receiving a completion call, calling each process in the process list of the process that received the completion call with an completion equivalent call; and
responsive to a process which is a compensation pair receiving a completion call:
running the compensation task if the call indicates that compensation task should be run;
forgetting the compensation task if the call indicates that compensation task should be forgotten; and
deleting the record of each process in each process list after it has been called with a completion call and has returned.

8. A method as claimed in claim 7 wherein the step of maintaining a process list is responsive to a process that does not support the completion call such that it does not add a record of such a process to the process list.

9. A method as claimed in claim 7 wherein the step of maintaining a process list is responsive to a process that indicates that it does not want to be called with the completion method such that it does not add a record of such a process to the process list.

10. A computer program product, recorded on a medium, comprising instructions which when executed on a data porcessing system, causes said system to carry out a method comprising the steps of:
running a workflow application, the application comprising a plurality of components, each component performing a defined function, and one or more completion steps, the plurality of components and the one or more completion steps being arranged to form a graph, wherein one or more components are designated as primary tasks and each primary task is paired with none, one, or more other components which are designated as compensating tasks;
interpreting and executing the graph wherein each time a primary task is run any compensating tasks that are paired with it are not run but added to a compensation group; and
responsive to executing a completion step, completing a subset of the compensation group wherein the subset of the compensation group is not involved in subsequent completion of the compensation group.

11. A computer program product as claimed in claim 10 wherein the one or more completion steps indicate failure for a subset of the compensation group and the step of completing a subset of the compensation group runs the compensating tasks contained in the subset of compensation group.

12. A computer program product as claimed in claim 10 wherein the one or more completion steps indicate success for a subset of the compensation group and the step of completing a subset of the compensation group forgets the compensating tasks in the subset of the compensation group.

13. A computer program product as claimed in claim 11 wherein each of the one or more completion steps indicates either success or failure for a subset of the compensation group, wherein the step of completing a subset of the compensation group is further responsive to the completion step indicating failure and the method further comprises the step:
responsive to executing a completion step that indicates success for a subset of the compensation group, forgetting the compensating tasks in the subset of the compensation group wherein the subset of the compensation group is not involved in subsequent completion of the compensation group.

14. The computer program product of claim 13 wherein the method further comprises the steps of:
responsive to a completion step indicating success which shares the same next component in the graph with one or more completion steps indicating failure, completing the compensation group by forgetting all compensating tasks involved in the compensation group; and
responsive to a completion step indicating failure which shares the same next component in the graph with one or more completion steps which indicate success, completing the compensation group by running all compensating tasks involved in the compensation group.

15. A computer program product as claimed in claim 10 wherein: a component which comprises one or more other components is a process, the compensation group comprising one or more processes, all primary and compensating tasks being defined in one or more compensation pair processes each of which comprises at most one primary task and at most one compensating task; and
the method further comprising the step of:
responsive to a primary task failing which has an associated compensation task, forgetting the compensating task such that is not part of the compensation group.

16. A computer program product as claimed in claim 15 wherein at least one of the one or more processes contained in the compensation group comprise one or more other process and the method further comprises the steps of:
maintaining, in each process that runs inside the compensation group, a process list containing a record of other processes run within that process as part of the compensation group;
responsive to a completion step, calling each process in the process list maintained for the process in which the completion step was contained, wherein the call is a completion call which indicates whether compensating tasks should be run or forgotten;
responsive to a process which is not a compensation pair receiving a completion call, calling each process in the process list of the process that received the completion call with an completion equivalent call; and
responsive to a process which is a compensation pair receiving a completion call;
running the compensation task if the call indicates that compensation task should be run;
forgetting the compensation task if the call indicates that compensation task should be forgotten; and
deleting the record of each process in each process list after it has been called with a completion call and has returned.

17. A computer program product as claimed in claim 16 wherein the step of maintaining a process list is responsive to a process that does not support the completion call such that it does not add a record of such a process to the process list.

18. A computer program product as claimed in claim 16 wherein the step of maintaining a process list is responsive to a process that indicates that it does not want to be called with the completion method such that it does not add a record of such a process to the process list.

19. A data processing system comprising a computer program product as claimed in claim 10, a memory in which said computer program product is stored and a processor for executing the computer program product to cause said system to run such a workflow application.

20. A method of running a software application represented by a workflow graph of interconnected executable components created using a graphical user interface, the graph comprising:
process representations having inputs, outputs and executable components, one or more of said components including a compensation pair which comprises a primary task and a compensation task compensating for said primary task; and
successful and unsuccessful completion step representations selectively associated with a process to indicate success or failure thereof;
said method comprising the steps of:
executing the primary tasks of a process in accordance with the workflow graph to produce a result;
executing an associated successful or unsuccessful completion step, depending on the result of execution of the primary tasks of said process;
in response to execution of an unsuccessful completion step, executing compensation tasks in the one or more compensation pairs within said process whose primary tasks have executed; and
in response to execution of a successful completion step committing the results of previously executed primary tasks in one or more compensation pairs within said process.

21. A method as claimed in claim 20 wherein said graph associates both a successful and an unsuccessful completion step representation with an end point of a compensation group consisting of a plurality of processes, whereby said method must either compensate or commit the results of the primary tasks of compensation pairs within said compensation group which have not otherwise been compensated or committed when said end point is reached.

22. A method as claimed in claim 21 wherein said graph may additionally associate only an unsuccessful completion step representation with an output of an inner process within a compensation group whereby said method comprises the further steps, in response to execution of said unsuccessful completion step, of executing the compensation tasks of compensation pairs within said inner process and otherwise deferring compensation of compensation pairs within said inner process pending the outcome of the completion steps of the compensation group when said end point is reached.

23. A method as claimed in claim 21 wherein said graph may additionally associate only a successful completion step representation with an output of an inner process within a compensation group whereby said method comprises the further steps, in response to execution of said successful completion step, of committing the results of already executed primary tasks within said inner process to prevent their subsequent compensation notwithstanding failure of the compensation group.

24. A method as claimed in claim 21 which includes the step of registering a process which is part of a compensation group to have its compensation decisions made in dependence on the outcome of the compensation group.

25. A method as claimed in claim 24 in which said registration task includes the step of creating a list of all compensation pairs within said compensation group and removing compensation pairs which are part of an inner process from said list in response to execution of a completion step for that inner process.

26. A method as claimed in claim 20 in which execution of a compensation task for a compensation pair causes the undoing of the actions of the corresponding primary tasks.

27. A method as claimed in claim 20 in which execution of a compensation task for a compensation pair causes the corresponding primary task to be retried.

28. A computer program product, recorded on a medium, comprising instructions for running a software application represented by a workflow graph of interconnected executable components creating using a graphical user interface, the graph comprising:
process representations having inputs, outputs and executable components, one of rmore of said components including a compensation pair which comprises a primary task and a compensation task compensating for said primary task; and
successful and unsuccessful completion step representations selectively associated with a process to indicate success or failure thereof;
the instructions, when executed on a data processing system causing said system to carry out a method comprising the steps of:
executing the primary tasks of a process in accordance with the workflow graph to produce a result;
executing an associated successful or unsuccessful completion step, depending on the result of execution of the primary tasks of said process;
in response to execution of an unsuccessful completion step, executing compensation tasks in the one or more compensation pairs within said process whose primary tasks have executed; and
in response to execution of a successful completion step committing the results of previously executed primary tasks in one or more compensation pairs within said process.

29. A computer program product as claimed in claim 28 wherein said graph associates both a successful and an unsuccessful completion step representation with an end point of a compensation group consisting of a plurality of processes, whereby said method must either compensate or commit the results of the primary tasks of compensation pairs within said compensation group which have not otherwise been compensated or committed when said end point is reached.

30. A computer program product as claimed in claim 29 wherein said graph may additionally associate only an unsuccessful completion step representation with an output of an inner process within a compensation group whereby said method comprises the further steps, in response to execution of said unsuccessful completion step, of executing the compensation tasks of compensation pairs within said inner process and otherwise deferring compensation of compensation pairs within said inner process pending the outcome of the completion steps of the compensation group when said end point is reached.

31. A computer program product as claimed in claim 29 wherein said graph may additionally associate only a successful completion step representation with an output of an inner process within a compensation group whereby said method comprises the further steps, in response to execution of said successful completion step, of committing the results of already executed primary tasks within said inner process to prevent their subsequent compensation notwithstanding failure of the compensation group.

32. A computer program product as claimed in claim 29 which includes the step of registering a process which is part of a compensation group to have its compensation decisions made in dependence on the outcome of the compensation group.

33. A computer program product as claimed in claim 32 in which said registration task includes the step of creating a list of all compensation pairs within said compensation group and removing compensation pairs which are part of an inner process from said list in response to execution of a completion step for that inner process.

34. A computer program product as claimed in claim 28 in which execution of a compensation task for a compensation pair causes the undoing of the actions of the corresponding primary tasks.

35. A computer program product as claimed in claim 28 in which execution of a compensation task for a compensation pair causes the corresponding primary task to be retried.

36. A data processing system for running a software application represented in said system by a workflow graph comprising process representations having inputs, outputs and executable components, one or more of said components including a compensation pair which comprises a primary task and a compensation step compensating for said primary task, and successful and unsuccessful completion step representations selectively associated with a process to indicate success or failure thereof, said system comprising:
means for executing the primary tasks of a process in accordance with said workflow graph to produce a result;
completion means for executing an associated successful or unsuccessful completion step, depending on the result of execution of the primary tasks of said process;
compensation means responsive to execution of an unsuccessful completion step to execute the compensation tasks in the one or more compensation pairs within said process whose primary tasks have executed; and
commitment means responsive to execution of a successful completion step to commit the results of previously executed primary tasks in one or more compensation pairs within said process.

37. A system as claimed in claim 36 wherein said graph associates both a successful and an unsuccessful completion step representation with an end point of a compensation group consisting of a plurality of processes, whereby the primary tasks of compensation pairs within said compensation group which have not otherwise been compensated or committed must either be compensated by said compensation means or committed by said commitment means when said end point is reached.

38. A system as claimed in claim 37 in which said graph may additionally associate only an unsuccessful completion step with an output of an inner process within a compensation group whereby, in response to execution of an unsuccessful completion step, said compensation means will execute the compensation tasks in compensation pairs within said inner process but otherwise will defer compensation pending the outcome of the compensation group at said end point.

39. A system as claimed in claim 39 in which said graph may additionally associate only a successful completion step representation with an output of an inner process within a compensation group whereby, in response to said inner process succeeding and the subsequent commitment of the results of already executed primary tasks within said inner process by said commitment means, said commitment means prevents their subsequent compensation notwithstanding failure of the compensation group.

40. A system as claimed in claim 37 further including registration means for enabling a process which is part of a compensation group to register to have its compensation decisions made in dependence on the outcome of the compensation group.

41. A system as claimed in claim 40 in which said registration means includes a list of all compensation pairs within the compensation group, execution of a completion step for an inner process causing removal of compensation pairs within said inner process from said list.

42. A system as claimed in claim 36 wherein the compensation means is arranged to undo the actions of the primary tasks,

43. A system as claimed in claim 36 wherein the compensation means is arranged to retry the actions of the primary tasks.
